(19) United States
(12) Patent Application Publication
(10) Pub. No.: US 2019/0336892 A1
(43) Pub. Date: Nov. 7, 2019

(54) Reciprocating Pressure Backwash Anti-blocking Filter

(71) Applicant: Xiao Jun ZHANG, Guizhou (CN)

(72) Inventor: Xiao Jun ZHANG, Guizhou (CN)

(21) Appl. No.: 15/968,760

(22) Filed: May 2, 2018

(51) Int. Cl. B01D 29/66; B01D 29/11

(52) U.S. Cl. CPC B01D 29/665; B01D 2201/202; B01D 29/114

(57) ABSTRACT

The utility model provides a reciprocating pressure backwash anti-blocking filter comprising upper and lower substrate layers. A rubber layer is disposed between the two substrate layers to form a stack structure. The upper and lower substrate layers are formed by a material having a certain strength and a hardness, e.g., Feilin film. The filter not only overcomes the difficulty of drilling a large opening, but also, each opening after driving can be narrowed to a certain extent according to a proportion so as to generate friction to a probe. Moreover, the stack structure is firm and can be taken as a layer of independent assembly. The filter is easily assembled and thus is suitable to replace the existing product which can be widely applied.

### BACKGROUND OF THE INVENTION

The utility model relates to the technical field of filtration and in particular to a reciprocating pressure backwash anti-blocking filter for a liquid containing solid floats.

Filtration is an operation of enabling a liquid or gas in a suspension (or particles containing solid) to pass through a media with an effect of driving force or other external forces, wherein the solid particles and other substances are entrapped by the filter media (in order) to separate the solid and other substances from the liquid or gas. The physical filtering technique for processing solid floats in the liquid is widely applicable to various industries, like Aquaculture, Aquatics and Waste Water Management etc. Commonly use screen-type filtering device is heavily used due to its characteristics like simple structure and low cost. The size of a circulating mesh opening of the screen is closely related to the filtering effect.

When using the screen-type filtering device, usually in an area that needs continuous filtration on a long term basis, the filtering is not effective if the circulating mesh opening of the screen is oversize or undersize. An oversize mesh will allow the particles to pass through, the accumulated particles on the surface of the screen will block the mesh opening of an undersize mesh, if blockage is not discovered in time and clear, will results in mortality of life stocks and equipment failure. At this time, a manual cleanup or screen replacement is required.

### BRIEF SUMMARY OF THE INVENTION

This technical issue to be resolved in this utility model is providing a reciprocating pressure backwash anti-blocking filter that can efficiently overcome the above-mentioned issue. This filter will provide a better filtering effect, will not block the mesh opening, ease of use and easy maintenance.

In order to resolve the above-mentioned technical issue, the utility model provides a reciprocating pressure backwash anti-blocking filter: comprising a filter screen that has a pressure chamber on one side, wherein a power device that may form a driving force is placed within the pressure chamber; an output end of the power device is connected with a pressure plug; the shape of the pressure plug is adapted to the shape of the cross section of the pressure chamber; the pressure chamber is divided into upper and lower portions by the pressure plug; the pressure plug moves up and down to separate solid particles of the filter screen from the filter screen.

In the above structure, the filter screen encloses to form the pressure chamber.

In the above structure, the power device includes a self-driving motor, a connecting rod and the pressure plug; one end of the connecting rod is connected with an output end of the self-driving motor; the other end of the connecting rod is connected with the pressure plug; and the pressure plug makes reciprocating motion in the pressure chamber to form the driving force to enable the liquid to backwash the filter screen.

The filter screen of the utility model is placed on one side of the pressure chamber; with the effect of the power device, the pressure chamber forms the driving force capable of backwashing the filter screen to separate the floats accumulated on the filter screen from the filter screen so as to prevent blockage of the filter, and thus achieving optimal constant filtration.

### BRIEF DESCRIPTION OF THE DRAWINGS

FIG. 1 is a global structural schematic diagram of a reciprocating pressure backwash anti-blocking filter of the utility model in one state;

FIG. 2 is a global structural schematic diagram of the reciprocating pressure backwash anti-blocking filter of the utility model in another state;

FIG. 3 is a state exploded schematic diagram of the reciprocating pressure backwash anti-blocking filter of the utility model;

FIG. 4 is another state exploded schematic diagram of the reciprocating pressure backwash anti-blocking filter of the utility model;

In the figures: 10, filter screen; 20, pressure chamber; 30, power device; 31, driving motor; 32, connecting rod; 33, pressure plug; 40, floats.

### DETAILED DESCRIPTION OF THE INVENTION

The utility model is further specified below in conjunction with the accompanying drawings.

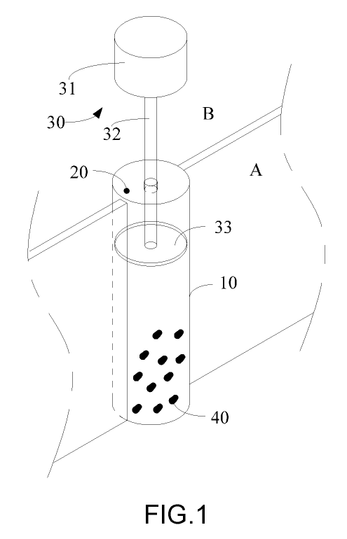

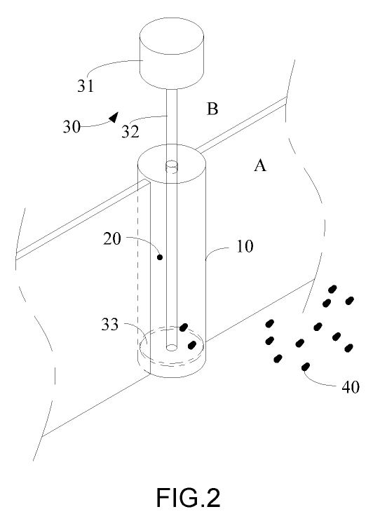

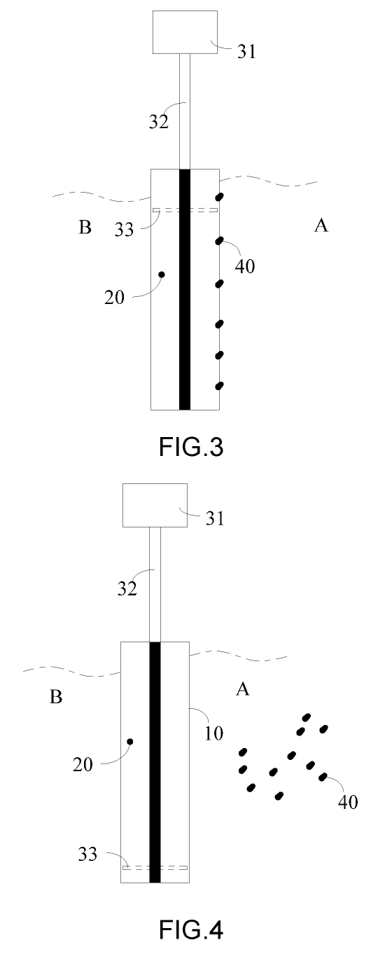

As shown in FIGS. 1-2, the reciprocating pressure backwash anti-blocking filter of the utility model is generally used for liquid filtering and is generally installed between a liquid to be filtered and a filtered liquid. The liquid to be filtered is filtered via the reciprocating pressure backwash anti-blocking filter with the effect of a driving force or an external force. In this embodiment, as shown in FIGS. 3-4, the liquid to be filtered is at A, the filtered liquid is at B, and the liquid at A flows to B via the filter in the effect of differential pressure. The reciprocating pressure backwash anti-blocking filter includes a filter screen 10. The filter screen 10 encloses to form a pressure chamber 20. The filter screen 10 is in a cylindrical or rectangular shape. The pressure chamber 20 is provided with a power device 30 capable of forming a driving force. The pressure device 30 includes a self-driving motor 31, a connecting rod 32 and a pressure plug 33. One end of the connecting rod 32 is connected with an output end of the self-driving motor 31, and the other end of the connecting rod 32 is connected with the pressure plug 33. The shape of the pressure plug 33 is adapted to that of the cross section of the pressure chamber 20. The pressure chamber 20 is divided into upper and lower portions by the pressure plug 33. The pressure plug 33 moves up and down to separate the solid floats 40 of the filter screen 10 from the filter screen 10. The pressure plug 33 makes reciprocating motion in the pressure chamber 20 to form the driving force to enable the liquid to backwash the filter screen 10. The type of the driving motor 31 in this embodiment is not limited, as long as it can provide a power for moving up and down, e.g., a linear motor or a rotational motor with a piston rod.

In the work process, the self-driving motor 31 provides power for the pressure plug 33 to make reciprocating motion. Reciprocating motion of the pressure plug 33 continuously changes the pressure in the pressure chamber, so that the pressure of the internal liquid changes circularly from positive to negative, and accordingly, liquid through the filter screen 10 forms reciprocating water flow in and out so as to form a backwash effect to the filter screen 10. The solid floats in the liquid cannot be accumulated on the surface of the filter screen 10, thereby achieving the anti-blocking effect.

The aforementioned contents are only preferred embodiments of the patent, and are not intended to limit the scope of the patent, and any equivalent structures or equivalent process transformations, which are made using the description and the contents of the drawings, is directly or indirectly applied to other relevant technical fields, and belong to the protection scope of the patent.

What is claimed is:

1. A reciprocating pressure backwash anti-blocking filter, comprising a filter screen that has a pressure chamber on one side, wherein a power device that may form a driving force is disposed in the pressure chamber; an output end of the power device is connected with a pressure plug; the shape of the pressure plug is adapted to the shape of the cross section of the pressure chamber; the pressure chamber is divided into upper and lower portions by the pressure plug; the pressure plug moves up and down to separate solid floats of the filter screen from the filter screen.

2. The reciprocating pressure backwash anti-blocking filter of claim 1, characterized in that: the filter screen encloses to form the pressure chamber.

3. The reciprocating pressure backwash anti-blocking filter of claim 2, characterized in that: the power device includes a driving motor, a connecting rod and the pressure plug; one end of the connecting rod is connected with an output end of the self-driving motor; the other end of the connecting rod is connected with the pressure plug; and the pressure plug makes reciprocating motion in the pressure chamber to form the driving force to enable the liquid to backwash the filter screen.
